(19) United States
(12) Patent Application Publication
(10) Pub. No.: US 2010/0214486 A1
(43) Pub. Date: Aug. 26, 2010

(54) Image Signal Processing Apparatus, Method of Controlling the Same, and Television Signal Receiving Apparatus

(76) Inventor: Takanobu Sasaki, Fukaya-shi (JP)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/637,506

(22) Filed: Dec. 14, 2009

(30) Foreign Application Priority Data
Feb. 25, 2009 (JP) 2009-042704

(51) Int. Cl. H04N 5/00; G06K 9/40; H04N 5/455

(52) U.S. Cl. 348/607; 382/275; 348/726; 348/E05.001

(57) ABSTRACT

According to one embodiment, a sharpening module and a grayscale smoothing module are provided. The smoothing module smoothes and reduces grayscale differences in a plain area of an input digital image signal, according to a parameter. A frequency state detection module detects a frequency state of the input digital image signal. A first case to be detected is that lower-frequency components are substantially fewer than higher-frequency components. A second case to be detected is that the lower-frequency components are substantially more than the higher-frequency components. A correction parameter output module outputs a correction parameter which enhances a smoothing process more when the second case is detected than when the first case is detected, the smoothing process being performed by the smoothing module.

### CROSS-REFERENCE TO RELATED APPLICATIONS

This application is based upon and claims the benefit of priority from Japanese Patent Application No. 2009-042704, filed Feb. 25, 2009, the entire contents of which are incorporated herein by reference.

### BACKGROUND

1. Field

One embodiment of the invention relates to an image signal processing apparatus, a method of controlling the image signal processing apparatus, and a television signal receiving apparatus.

2. Description of the Related Art

In recent years, in digital image signal recording/reproducing apparatuses and digital image signal sending/receiving apparatuses, compression and encoding/decoding processes have been performed on digital image signals. For compression and encoding/decoding schemes for digital image signals, the Moving Picture Experts Group (MPEG)-2 scheme, for example, is known.

It is known that when a digital image signal compressed and encoded by the MPEG-2 scheme is decoded, block noise occurs. The block noise is noticeable in a plain area of an image as a luminance difference.

There are techniques related to image processing and image processing methods that perform a smoothing process on an image signal to reduce such noise (e.g., Jpn. Pat. Appln. KOKAI Publication No. 2008-160440).

Meanwhile, a technique is developed in which the sharpness of an image can be emphasized even in a large screen display by performing a sharpening process on high-frequency components (e.g., Jpn. Pat. Appln. KOKAI Publication No. 2007-324764).

In the technique in Jpn. Pat. Appln. KOKAI Publication No. 2008-160440 in which a smoothing process is performed to reduce noise, a characteristic for always obtaining a constant smoothing effect is set. Therefore, the smoothing process may not effectively function in some contents of pictures.

Performing a sharpening process on high-frequency components to sharpen an image, as described in Jpn. Pat. Appln. KOKAI Publication No. 2007-324764, and performing a smoothing process to reduce noise, as described in Jpn. Pat. Appln. KOKAI Publication No. 2008-160440, are mutually contradictory in a way. In the conventional techniques, since individual problems are dealt with, overall functions that an assembled image signal processing apparatus can exert cannot be predicted and thus noise may be enhanced.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an illustrative diagram of a configuration of an image signal processing apparatus according to one embodiment of the present invention;

FIG. 2 is an illustrative diagram showing characteristics of modules to describe operations of the image signal processing apparatus in FIG. 1 and functions of the operations;

FIG. 3 is a diagram showing an exemplary configuration of a frequency state detection module 113a in FIG. 1;

FIG. 4 is a diagram showing an exemplary configuration of a computing module 200 in FIG. 3;

FIG. 5 is a diagram showing an exemplary basic configuration of a grayscale smoothing module 120b in FIG. 1;

FIG. 6 is a diagram showing an exemplary configuration of a micro-change extraction module in FIG. 5;

FIGS. 7A to 7C are diagrams showing examples of input/output characteristics of a micro-amount extraction module in the module in FIG. 6; and

FIG. 8 is an overall block diagram of a digital television broadcast receiving apparatus to which the present invention is applied.

### DETAILED DESCRIPTION

Various embodiments according to the invention will be described hereinafter with reference to the accompanying drawings.

In an aspect of the present invention, an image signal processing apparatus, a method of controlling the image signal processing apparatus, and a television signal receiving apparatus are provided that can perform an appropriate smoothing process by allowing a smoothing process to obtain adaptive operations according to the frequency components of an input digital image signal.

In another aspect of the present invention, an image signal processing apparatus, a method of controlling the image signal processing apparatus, and a television signal receiving apparatus are provided that can obtain an overall improvement in image quality even when a sharpening process is performed on high-frequency components, by performing an appropriate smoothing process in conjunction or cooperation with the sharpening process.

In one embodiment of the present invention, basically, a smoothing module is provided which is configured to smooth and reduce grayscale differences in a plain area of an input digital image signal, according to a parameter. A frequency state detection module is configured to detect a frequency state of the input digital image signal and return a result indicating either a first case wherein lower-frequency components lower than a predetermined frequency are substantially fewer than higher-frequency components higher than the predetermined frequency, or a second case wherein the lower-frequency components are substantially more than the higher-frequency components. A correction parameter output module is configured to output a correction parameter which enhances a smoothing process more when the detected result indicates the second case than when the detected result indicates the first case, the smoothing process being performed by the smoothing module.

In the present invention, a sharpening process performed by a sharpening module can be enhanced more using the correction parameter when the detected result indicates the second case than when the detected result indicates the first case, the sharpening module being provided in a previous stage of the smoothing module.

According to the present invention, in a smoothing process, adaptive operations are performed according to the frequency components of an input digital image signal and thus noise is less likely to occur. Also, by the addition of a sharpening module and adaptive operations of the sharpening module, even when a sharpening process is performed on high-frequency components, an appropriate smoothing process is performed in conjunction with the sharpening process, enabling to obtain an overall improvement in image quality.

More specific description will be made below.

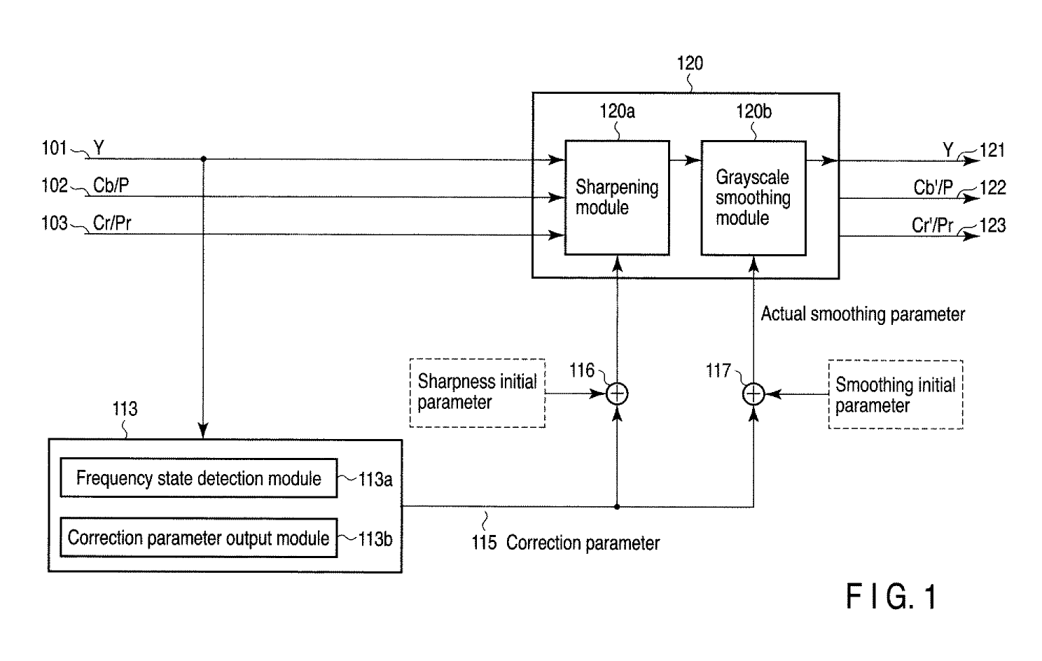

FIG. 1 shows one embodiment of the present invention. A digital luminance signal Y is input to an input terminal 101, a color difference signal Cb or Pb is input to an input terminal 102, and a color difference signal Cr or Pr is input to an input terminal 103.

The luminance signal Y and the color difference signals Cb/Pb and Cr/Pr are input to a sharpening/grayscale smoothing processing module 120. The sharpening/grayscale smoothing processing module 120 includes a sharpening module 120a which performs a sharpening process on a digital image signal; and a grayscale smoothing module 120b which performs a smoothing process on an output from the sharpening module 120a.

The luminance signal Y at the input terminal 101 is input to a frequency analysis/correction parameter generating module 113. The frequency analysis/correction parameter generating module 113 acquires a correction parameter 115 in accordance with a frequency distribution of an input digital image signal. Therefore, the frequency analysis/correction parameter generating module 113 includes a frequency state detection module 113a which detects a frequency distribution state from a histogram of an input digital image signal; and a correction parameter output module 113b.

The correction parameter 115 output from the correction parameter output module 113b is input to adders 116 and 117 serving as correction modules.

The adder 116 adds the correction parameter 115 to a sharpness initial parameter and provides the resulting parameter to the sharpening module 120a. As a result, an increase and decrease in the degree of emphasis of high-frequency components in the sharpening module 120a are controlled. On the other hand, the adder 117 adds the correction parameter 115 to a smoothing initial parameter and provides the resulting parameter to the grayscale smoothing module 120b. As a result, in the grayscale smoothing module 120b, the degree of a smoothing process is enhanced or reduced.

As described above, when it is determined that an input digital image signal has less of a high-frequency portion, the sharpening module 120a increases sharpness to increase image quality. At that time, as a side effect, noise in a low-frequency portion (a plain area of an image) increases. Thus, the grayscale smoothing module 120b uses the correction parameter 115 as offset data for the smoothing initial parameter and uses a result of the computation as an actual smoothing parameter for a smoothing process. Hence, the grayscale smoothing module 120b performs a smoothing process using the actual smoothing parameter.

The sharpening/grayscale smoothing processing module 120 outputs a luminance signal Y′ and color difference signals Cb′/Pb′ and Cr′/Pr′ obtained finally to output terminals 121, 122, and 123, respectively.

By employing the above-described configuration, even in a case in which noise increases as a result of performing a sharpening process adapting to an input frequency distribution, a strong smoothing process can also be applied at the same time. Thus, the influence of the increase in noise on final outputs can be suppressed.

Description is further added. The sharpening module 120a acquires histogram data of an input digital image signal and performs a high-frequency emphasis process in accordance with a frequency distribution of the input signal.

It has been found that the grayscale smoothing module 120b performs a smoothing process on a plain area of an image signal, which is effective for stripes or block noise caused by grayscale degradation. Note, however, that when a parameter that enhances the effect is selected and fixed, trouble that the entire image becomes blurred occurs.

In view of this, in the present invention, when, as described above, high-frequency emphasis is performed in conjunction with a result of detection of a frequency distribution, a grayscale smoothing parameter is offset using the detection result so as to be enhanced, whereby an increase in noise in a high-frequency emphasized portion and a plain portion of an image signal is suppressed.

Note that although the above describes a system for the luminance signal Y, the same process may, of course, be performed on the color difference signals (Cb(Pb)/Cr(Pr)).

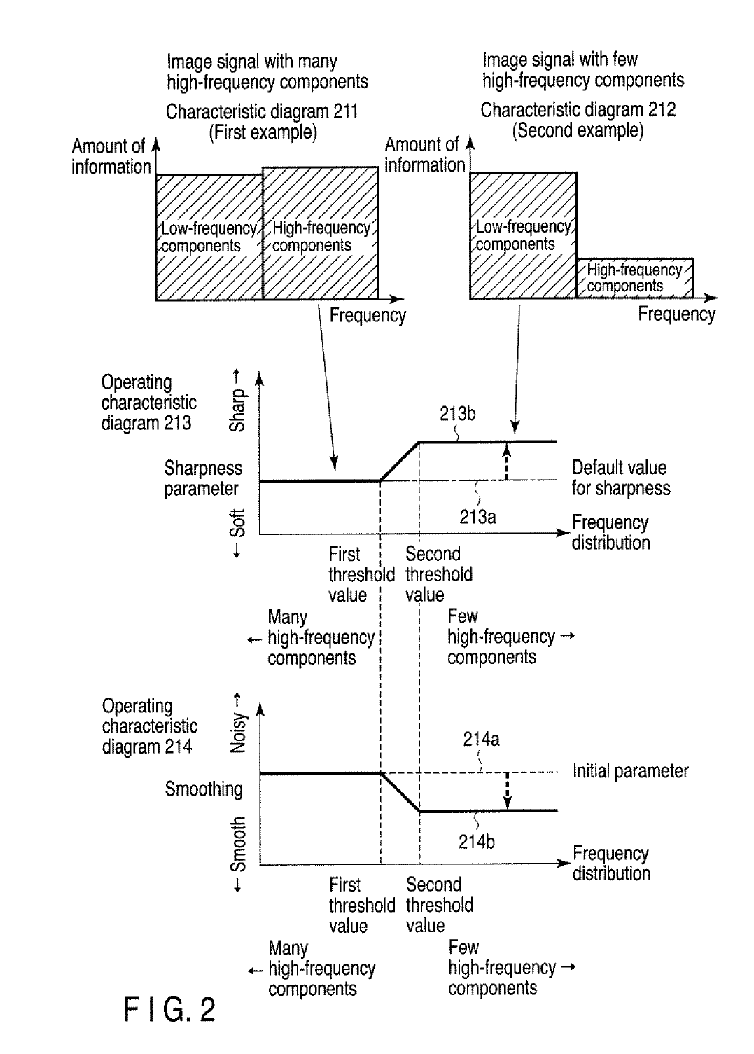

FIG. 2 is characteristic and operating characteristic illustrative diagrams showing characteristic operations of the apparatus shown in FIG. 1. Characteristic diagrams 211 and 212 in FIG. 2 respectively show first and second examples of a frequency distribution of an input digital image signal whose frequency is analyzed and detected by the frequency state detection module 113a.

The characteristic diagram 211 (first example) shows that, as a result of analysis, lower-frequency components which are lower than a frequency substantially at the center of the entire frequency band of the input digital image signal are few and higher-frequency components which are higher than the frequency are many. The characteristic diagram 212 (second example) shows that, as a result of analysis, lower-frequency components which are lower than a frequency substantially at the center of the entire frequency band of the input digital image signal are many and higher-frequency components which are higher than the frequency are few.

An operating characteristic diagram 213 shows the operating characteristic of the sharpening module 120a. The vertical axis represents the sharpness emphasis direction set by a parameter and a downward direction thereof indicates the degree of softening and an upward direction thereof indicates the degree of sharpening. The horizontal axis represents frequency distribution and the left thereof indicates a direction in which more high-frequency components are present and the right thereof indicates a direction in which fewer high-frequency components are present. Furthermore, an operating characteristic diagram 214 shows the operating characteristic of the grayscale smoothing module 120b. The vertical axis represents the direction of degree of smoothing set by a parameter and the downward direction thereof indicates the degree of smoothing and an upward direction thereof indicates the degree of noise. The horizontal axis represents frequency distribution and the left thereof indicates the direction in which more high-frequency components are present and the right thereof indicates a direction in which fewer high-frequency components are present.

In the operating characteristic diagram 213, a characteristic line 213a indicates a characteristic obtained by a sharpness initial parameter. When only the characteristic line 213a is used, the degree of sharpness is kept substantially constant regardless of frequency distribution.

In the operating characteristic diagram 214, a characteristic line 214a indicates a characteristic obtained by a smoothing initial parameter. When only the characteristic line 214a is used, the degree of smoothing is maintained substantially constant regardless of frequency distribution.

According to the present invention, the sharpening module 120a performs a sharpening process using a characteristic line 213b. The grayscale smoothing module 120b performs a smoothing process using a characteristic line 214b.

Specifically, in the case of a signal with many high-frequency components, sharpness remains at its default and thus the sharpening module 120a does not need to perform high-frequency emphasis. Therefore, for a parameter for when a signal with many high-frequency components is input, the sharpness initial parameter is maintained. However, when a signal with few high-frequency components is input, the degree of a sharpening process is enhanced to increase image quality (see the characteristic line 213b). For a parameter for this case, a correction parameter is added to the sharpness initial parameter to emphasize sharpness.

However, there is a tendency that, as a result of emphasizing sharpness, block noise which is hidden in originally low-frequency components increases or the signal-to-noise ratio of low-frequency components decreases.

In view of this, the grayscale smoothing module 120b adopts the characteristic line 214b. Specifically, in the case of a signal with many high-frequency components, a sharpness emphasis process is not performed and thus it can be considered that low-frequency noise does not increase. Thus, when a signal with many high-frequency components is input, the smoothing initial parameter is maintained. However, when a signal with few high-frequency components is input, in order to suppress the above-described increase in block noise and decrease in the signal-to-noise ratio of low-frequency components, a correction parameter is added to the smoothing initial parameter to enhance a smoothing process.

First and second threshold values are set at change points of the characteristic line 213b. Also, first and second threshold values are set at change points of the characteristic line 214b.

This is because, in order to prevent an output image from abruptly changing at a transition point of detection of a state in which the high-frequency components are many or few, a plurality of threshold values such as the first threshold value and the second threshold value are provided in an offset process for a parameter serving as control data, to slowly change image quality between two points or more.

As described above, in the conventional smoothing processing methods, dynamic control is not available for various conditions of an input image and thus a constant effect is always obtained for all scenes. However, by setting different parameters for some conditions of a scene, a more effective smoothing process can be performed.

Hence, in the present invention, as described above, when a function of raising image quality setting in conjunction with a result of detection of a frequency distribution is used, a grayscale creation parameter is strongly offset at the same time, whereby occurrence of noise can be suppressed. That is, even when an input digital image signal has considerably few high-frequency components and accordingly sharpness is increased, by applying strong smoothing at the same time, occurrence of block noise can be suppressed.

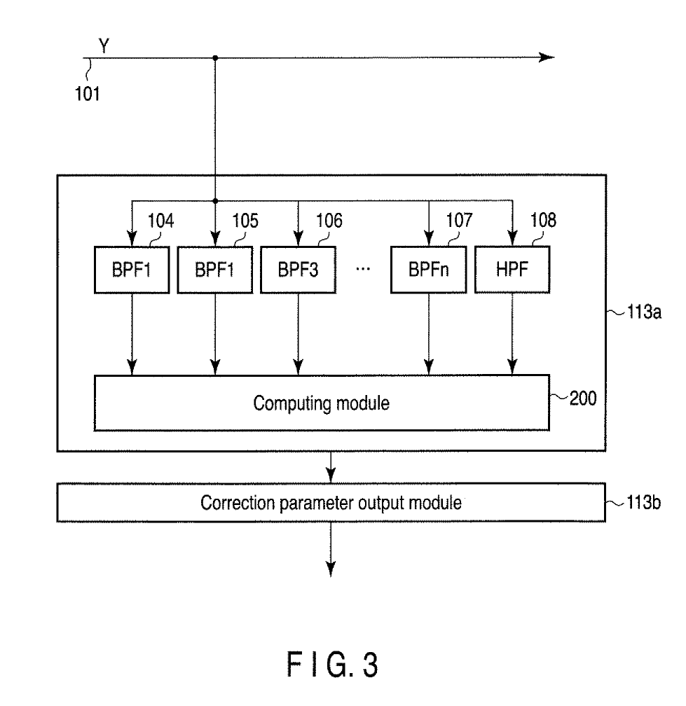

The present invention is not limited to the above-described embodiment. FIG. 3 shows an exemplary configuration of the frequency state detection module 113a. A luminance signal Y is input to a plurality of band-pass filters 104, 105, 106, 107, and 108 having different passbands and is frequency-resolved. Then, luminance signal components are input to a computing module 200 and weights are assigned to the signals of different bands and the resultant is output as frequency state detection data. The frequency state detection data is input to the correction parameter output module 113b and converted to a correction parameter.

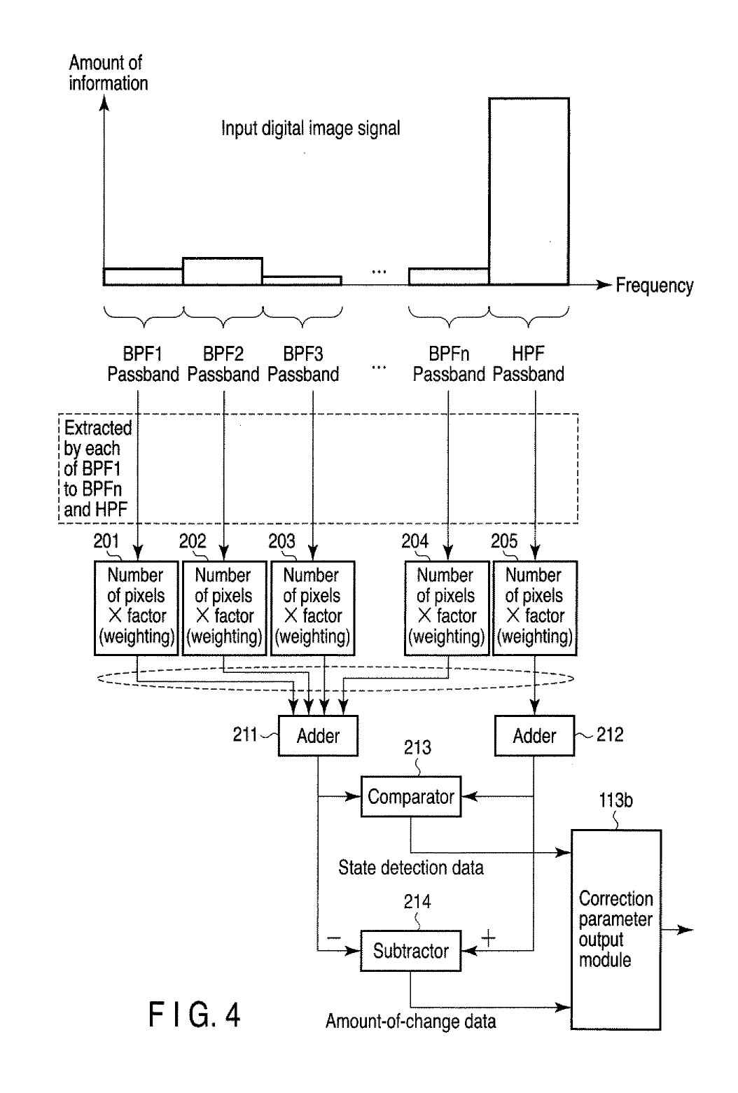

FIG. 4 shows an exemplary configuration of the computing module 200. Frequency-resolved signals of different bands are assigned weights by factor modules 201, 202, 203, 204, and 205, respectively. Weighting is performed such that when proportions of low-frequency components and high-frequency components are compared, the proportions are easily detected. In an example in the drawing, the configuration is such that outputs from the factor modules 201, 202, 203, and 204 are added together by an adder 211 and an output from the factor module 205 is input to an adder 212 and then outputs from the adders 211 and 212 are compared by a comparator 213. By adjusting weight values used in the factor modules 201, 202, 203, 204, and 205, a criterion for the magnitude relationship between an output from the adder 211 and an output from the adder 212 can be changed. The criterion is set based on, for example, statistical data which is obtained by a designer when various digital image signals are subjected to signal processing at the design stage. Therefore, an adjustment block which adjusts the weight values may be present or a switching block may be provided so that filter outputs taken in the adders 211 and 212 can be changed.

The outputs from the adders 211 and 212 are input to the comparator 213 and a subtractor 214. The subtractor 214 takes a difference value. The difference value indicates the amount of change in the state of a frequency distribution. This amount-of-change data is effective for generating a correction parameter between the first and second threshold values described in FIG. 2. State detection data output from the comparator 213 indicates a result of detection of a state of characteristic diagram 1 or characteristic diagram 2 described in FIG. 2.

The state detection data and the amount-of-change data are input to the correction parameter output module 113b. The correction parameter output module 113b is configured by, for example, a memory or arithmetic circuit having a lookup table and outputting a correction parameter based on the state detection data and the amount-of-change data.

The sharpening module 120a is configured, for example, to separate an input digital image signal into high-frequency components and low-frequency components and emphasize the high-frequency components according to a parameter. The sharpening module 120a is a block which combines the emphasized high-frequency components and the previously separated low-frequency components. The high-frequency components are extracted by a digital differentiating circuit and the low-frequency components are extracted by a digital filter circuit.

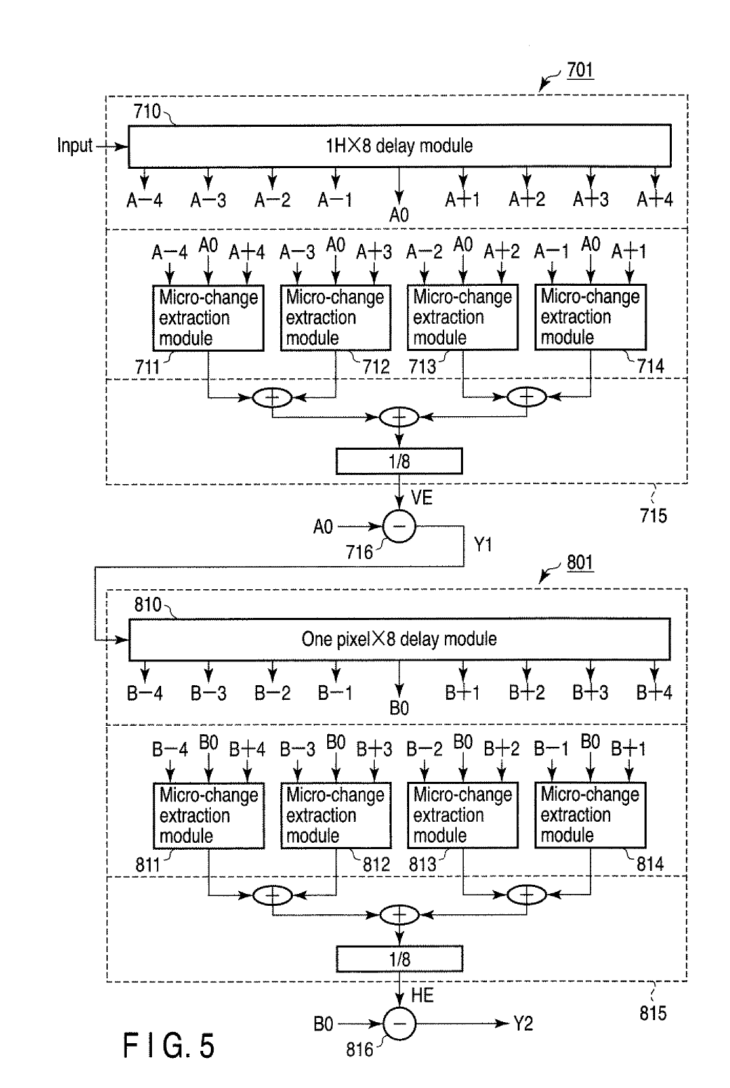

Next, exemplary basic configuration and exemplary basic operations of the grayscale smoothing module 120b will be described with reference to FIGS. 5 to 70. In FIG. 5, an input luminance signal Y is subjected to a smoothing process for its grayscale differences in the vertical direction by a vertical direction processing module 701 and is then subjected to a smoothing process for its grayscale differences in the horizontal direction by a horizontal direction processing module 801.

The vertical direction processing module 701 comprises, for example, a delay module 710 for eight lines, micro-change extraction modules 711, 712, 713, and 714, and an averaging module 715 which rounds outputs from the micro-change extraction modules 711 to 714. The horizontal direction processing module 801 comprises, for example, a delay module 810 for eight pixels, micro-change extraction modules 811, 812, 813, and 814, and an averaging module 815 which rounds outputs from the micro-change extraction modules 811 to 814.

Vertical modified data VE output from the averaging module 715 of the vertical direction processing module 701 is input to a subtractor 716. The subtractor 716 subtracts the modified data VE from central data A0 and thereby obtains an output luminance signal Y1 which is smoothed in the vertical direction. The luminance signal Y1 is input to the horizontal direction processing module 801 and supplied to a subtractor 816 as modified data HE for the horizontal direction. The subtractor 816 subtracts the modified data HE from central data B0 and thereby obtains an output luminance signal Y2.

In the vertical direction processing module 701, to the micro-change extraction module 711 are input central data A0 and data A+4 and data A−4 present at locations spaced from the central data A0 by four lines in the plus and minus directions. The micro-change extraction module 711 basically detects a difference between the central data A0 and the data A+4 and a difference between the central data A0 and the data A−4 to determine whether there are differences in grayscale between pixels, and extracts a smaller one of the differences. To the micro-change extraction module 712 are input central data A0 and data A+3 and data A−3 present at locations spaced from the central data A0 by three lines in the plus and minus directions. To the micro-change extraction module 713 are input central data A0 and data A+2 and data A−2 present at locations spaced from the central data A0 by two lines in the plus and minus directions. To the micro-change extraction module 714 are input central data A0 and data A+1 and data A−1 present at locations spaced from the central data A0 by one line in the plus and minus directions. Each of the micro-change extraction modules 712 to 714 also basically detects a difference between the central data A0 and one data and a difference between the central data A0 and the other data to determine whether there are differences in grayscale between pixels, and extracts a smaller one of the differences.

Outputs from the respective micro-change extraction modules 711 to 714 are added together by the averaging module 715 and an average value thereof is output as the foregoing modified data VE.

In the horizontal direction processing module 801, to the micro-change extraction module 811 are input central data B0 and data B+4 and data B−4 present at locations spaced from the central data B0 by four pixels in the plus and minus directions. The micro-change extraction module 811 basically detects a difference between the central data B0 and the data B+4 and a difference between the central data B0 and the data B−4 to determine whether there are differences in grayscale between pixels, and extracts a smaller one of the differences. To the micro-change extraction module 812 are input central data B0 and data B+3 and data B−3 present at locations spaced from the central data B0 by three pixels in the plus and minus directions. To the micro-change extraction module 813 are input central data B0 and data B+2 and data B−2 present at locations spaced from the central data B0 by two pixels in the plus and minus directions. To the micro-change extraction module 814 are input central data B0 and data B+1 and data B−1 present at locations spaced from the central data B0 by one pixel in the plus and minus directions. Each of the micro-change extraction modules 812 to 814 also basically detects a difference between the central data B0 and one data and a difference between the central data B0 and the other data to determine whether there are differences in grayscale between pixels, and extracts a smaller one of the differences.

Outputs from the respective micro-change extraction modules 811 to 814 are added together by the averaging module 815 and an average value thereof is output as the foregoing modified data HE.

The above-described process corresponds to detecting a change in grayscale in 8×8 pixel block units and performing, if there is a change in grayscale, a smoothing process so as to prevent the change from becoming noticeable. That is, block noise is reduced.

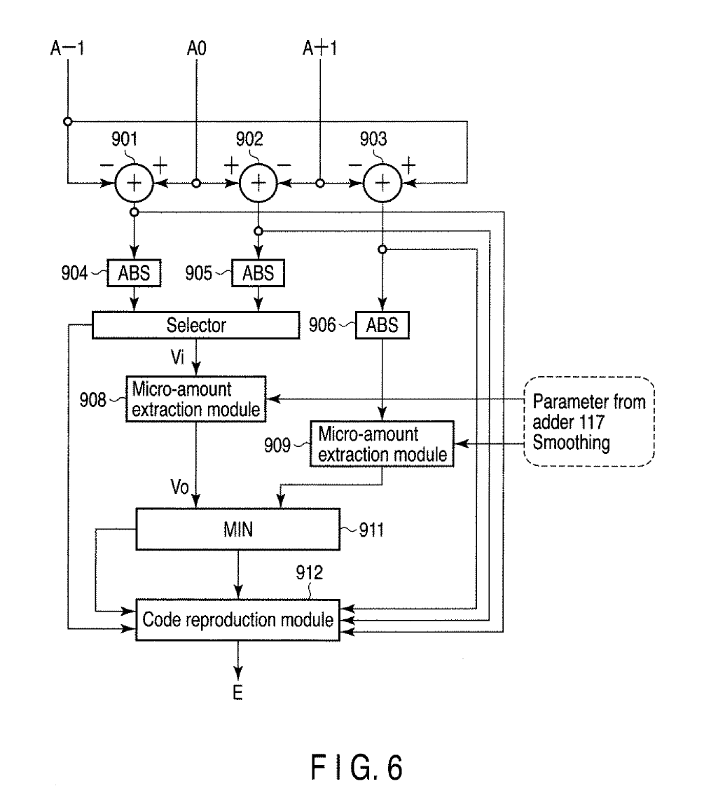

Here, parameters are provided to the micro-change extraction modules. FIG. 6 shows a representative exemplary configuration of one micro-change extraction module. To the micro-change extraction module are input central data A0 and data A+I and data A−I present at locations spaced from the central data A0 by I line(s) or pixel(s) in the plus and minus directions. I is any one of 1 to 4. A difference between the data A0 and the data A−I is computed by a subtractor 901 and converted to an absolute value by an absolute value module 904. Then, the absolute value is input to a selector 907. A difference between the data A0 and the data A+I is computed by a subtractor 902 and converted to an absolute value by an absolute value module 905. Then, the absolute value is input to the selector 907. The selector 907 selects a smaller one of the absolute values and supplies the selected absolute value to a micro-amount extraction module 908.

A difference between the data A−I and the data A+I is computed by a subtractor 903 and converted to an absolute value by an absolute value module 906. The absolute value is supplied to a micro-amount extraction module 909. The difference between the data A−I and the data A+I shows that the pixel level change increases or decreases as time elapses or there is no pixel level change.

The above-described detection form is considered to have the following patterns:

Pattern 1 . . . A−I<A0, A0<A+I, and A−I<A+I (increase with time)

Pattern 2 . . . A−I>A0, A0>A+I, and A−I>A+I (decrease with time)

Pattern 3 . . . A−I<A0, A0>A+I, and A−I=A+I (triangle)

Pattern 4 . . . A−I>A0, A0<A+I, and A−I=A+I (inverted triangle shape)

The input/output characteristics of the micro-amount extraction modules 908 and 909 are controlled by the aforementioned parameter from an adder 110. Outputs from the micro-amount extraction modules 908 and 909 are input to a minimum value detection module 911 and a smaller one of the outputs is selected. The selected data is input to a code reproduction module 912 to reproduce code and the reproduced code is adopted as modified data.

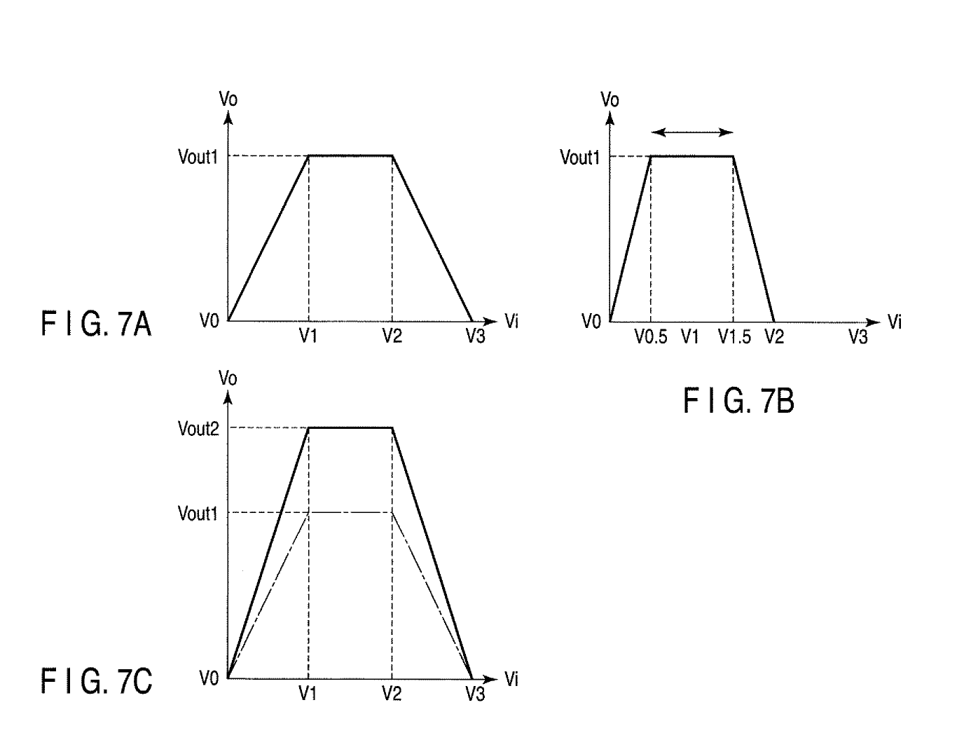

An initial state of the relationship between an input Vi and an output Vo of the micro-amount extraction modules 908 and 909 is set as shown in FIG. 7A, for example. First, while the value of the input Vi increases from zero to V1, the output Vo increases at a constant rate. When the value of the input Vi is between V1 and V2, the output Vo is maintained at a constant value Vout1. Then, when the value of the input Vi exceeds V2, the output Vo changes in a direction in which the output Vo decreases.

As a result, a smoothing process effect is gradually enhanced until the value of the input Vi reaches V1, and the smoothing process effect is maintained (does not change) when the value of the input Vi is between V1 and V2, and the smoothing process effect is weakened when the value of the input Vi is V2 or more. The reason why Vout1 is kept constant when the value of the input Vi is between V1 and V2 is because when the smoothing process effect frequently changes, noise is more likely to occur. The reason why the characteristic is such that the smoothing process effect is weakened when the value of the input Vi is V2 or more is because a picture is highly likely to be different than an originally intended grayscale smoothing target picture.

When the adder 110 adds a correction parameter described in FIG. 1 to an initial parameter, the relationship between the input Vi and the output Vo of the micro-amount extraction modules 908 and 909 obtains a conversion characteristic such as that shown in FIG. 7B or 7C, for example. When the relationship has such a characteristic, sensitivity to a change of the output Vo with respect to the input Vi increases. Therefore, the grayscale smoothing module 112 shown in FIG. 1 increases in its sensitivity at fade-in/fade-out and thus operates so as to reduce differences in grayscale level in a plain area.

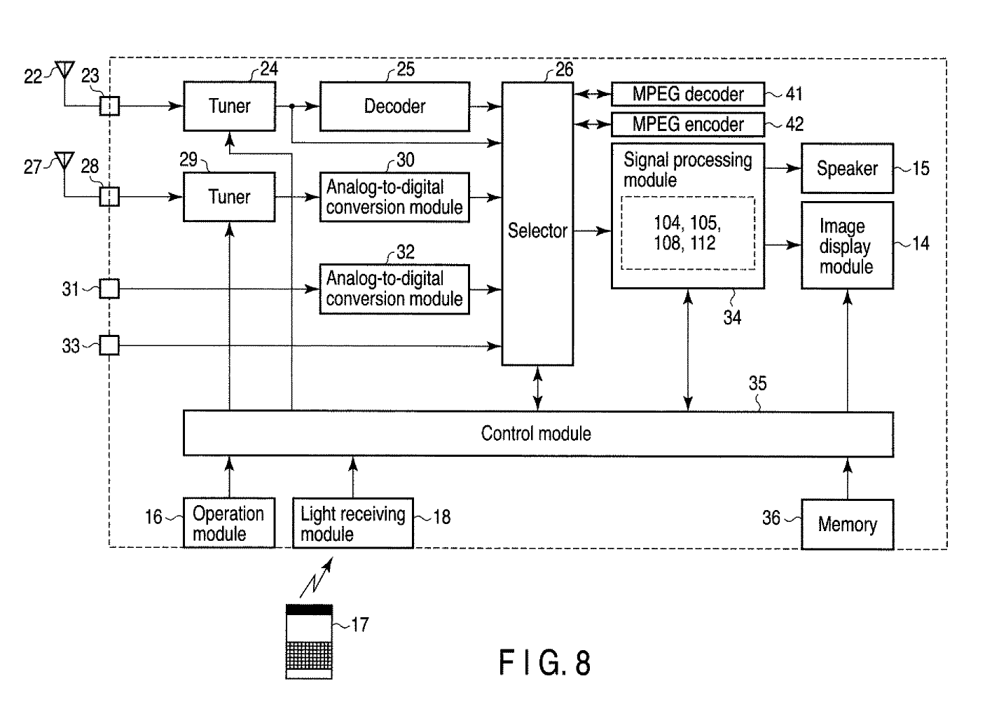

FIG. 8 schematically shows a signal processing system of a television signal receiving apparatus in which an image signal processing apparatus in the present invention is incorporated.

Main components of the image signal processing apparatus are incorporated in a signal processing module 34 and are controlled by a control module 35. A digital television broadcast signal received by an antenna 22 for receiving digital television broadcasts is supplied to a tuner 24 through an input terminal 23. The tuner 24 selects a signal of a desired channel from the input digital television broadcast signal and demodulates the signal. Then, the signal output from the tuner 24 is supplied to a decoder 25 and is subjected to a Moving Picture Experts Group (MPEG)-2 decoding process, together with, for example, an MPEG decoder 41.

The signal output from the tuner 24 is also directly supplied to a selector 26. It is also possible to demultiplex the signal into image and audio information, etc., and record the image and audio information in a recording apparatus (not shown) through the control module 35.

Furthermore, an analog television broadcast signal received by an antenna 27 for receiving analog television broadcasts is supplied to a tuner 29 through an input terminal 28. The tuner 29 selects a signal of a desired channel from the input analog television broadcast signal and demodulates the signal. Then, the signal output from the tuner 29 is digitized by an analog-to-digital conversion module 30 and then the digital signal is output to the selector 26.

Also, analog image and audio signals supplied to an analog signal input terminal 31 are supplied to an analog-to-digital conversion module 32 and digitized and then the digital signals are output to the selector 26. Furthermore, digital image and audio signals supplied to a digital signal input terminal 33 are directly supplied to the selector 26.

When a digitized signal is recorded in, for example, a recording apparatus, the signal is subjected to a compression process using a predetermined format, e.g., a Moving Picture Experts Group (MPEG)-2 scheme, by an MPEG encoder 42 with which the selector 26 is accompanied and then the compressed signal is recorded in the recording apparatus.

The selector 26 selects one pair of digital image and audio signals from the input digital image and audio signals at four locations and supplies the selected pair of signals to the signal processing module 34. The signal processing module 34 performs predetermined signal processing on the input digital image signal to provide image display on an image display module 14. For the image display module 14, for example, a flat panel display configured by a liquid crystal display or plasma display is adopted. The signal processing module 34 also performs predetermined signal processing on the input digital audio signal to convert the signal to an analog signal and outputs the analog signal to a speaker 15, whereby audio playback is performed.

In the television signal receiving apparatus, overall control of various operations including the above-described various receiving operations is performed by the control module 35. The control module 35 is a microprocessor including a central processing unit (CPU), etc. Operation information from an operation module 16 or operator (not shown) or operation information sent from a remote control 17 is received by a light receiving module 18 and the control module 35 processes the received operation information and thereby controls each module such that the operation content is reflected.

In this case, the control module 35 uses a memory 36. The memory 36 mainly comprises a read-only Memory (ROM) which stores a control program executed by the CPU; a random access memory (RAM) for providing the CPU with a work area; and a nonvolatile memory which stores various setting information, control information, etc.

Note that a plurality of signal processing systems which operate in parallel include, as a matter of course, a time adjustment buffer so that synchronization can be obtained. Although the above description shows a processing system for a luminance signal, a grayscale smoothing module may, of course, be provided to each of a color difference signal system and a color signal system. Although an 8×8 pixel block has been described as a micro-change detection range, the range is not limited thereto; various design changes may be made, such as a 4×4 pixel block or 16×16 pixel block, or processing modules for various blocks may be combined.

As described above, the present invention is useful for application to image signal processing apparatuses, television signal receiving apparatuses, recording/reproducing apparatuses, set-top boxes, etc.

While certain embodiments of the invention have been described, these embodiments have been presented by way of example only, and are not intended to limit the scope of the invention. Indeed, the novel methods and systems described herein may be embodied in a variety of forms; furthermore, various omissions, substitutions and changes in the form of the methods and systems described herein may be made without departing from the spirit of the invention. The accompanying claims and their equivalents are intended to cover such forms or modifications as would fall within the scope and spirit of the invention.

What is claimed is:

1. An image signal processing apparatus comprising:
a smoothing module configured to smooth and reduce grayscale differences in a plain area of an input digital image signal, according to a parameter;
a frequency state detection module configured to detect and obtain a detected result when a frequency state of the input digital image signal is detected, where the detected result indicates one of a first case and a second case, the first case being that in which lower-frequency components which are lower than a predetermined frequency are substantially fewer than higher-frequency components which are higher than the predetermined frequency, and the second case being that in which the lower-frequency components are substantially more than the higher-frequency components; and
a correction parameter output module configured to output a correction parameter which enhances a smoothing process more when the detected result indicates the second case than when the detected result indicates the first case, the smoothing process being performed by the smoothing module.

2. The image signal processing apparatus of claim 1, wherein a sharpening process performed by a sharpening module is enhanced more using the correction parameter when the detected result indicates the second case than when the detected result indicates the first case, the sharpening module being provided in a previous stage of the smoothing module.

3. The image signal processing apparatus of claim 2, wherein when the detected result indicates the first case, the sharpening process performed by the sharpness module and the smoothing process performed by the smoothing module are performed using their respective initial parameters.

4. The image signal processing apparatus of claim 1, wherein the frequency state detection module is configured to adjust the predetermined frequency to a higher or lower frequency.

5. The image signal processing apparatus of claim 4, wherein the frequency state detection module detects the frequency state in such a manner that frequency components of a plurality of different frequency bands are extracted from the input digital image signal and the extracted frequency components are assigned weights.

6. A method of controlling an image signal processing apparatus, which controls a sharpening module configured to emphasize high-frequency components of an input digital image signal according to a first parameter and a smoothing module configured to smooth and reduce grayscale differences in a plain area of an output digital image signal from the sharpening module according to a second parameter, the method comprising:
outputting, when a frequency state of the input digital image signal is detected, a detected result which indicates one of a first case and a second case, the first case being that in which lower-frequency components which are lower than a predetermined frequency are substantially fewer than higher-frequency components which are higher than the predetermined frequency, and the second case being that in which the lower-frequency components are substantially more than the higher-frequency component; and
generating and outputting a correction parameter for the first and second parameters to enhance a sharpening process and a smoothing process more when the detected result indicates the second case than when the detected result indicates the first case, the sharpening process being performed by the sharpening module and the smoothing process being performed by the smoothing module.

7. A television signal receiving apparatus comprising:
a receiving module which receives a broadcast signal;
a decoder which decodes the received signal and outputs a resulting digital image signal;
a signal processing apparatus which performs predetermined signal processing on the digital image signal;
a display module which displays the image signal processed by the signal processing apparatus; and
a control module which performs overall control of signal processing operations, wherein
the signal processing apparatus includes:
a sharpening module configured to emphasize high-frequency components of an input digital image signal according to a first parameter;
a smoothing module configured to smooth and reduce grayscale differences in a plain area of an output digital image signal from the sharpening module according to a second parameter;
a frequency state detection module configured to detect and obtain a detected result when a frequency state of the input digital image signal is detected, where the detected result indicates one of a first case and a second case, the first case being that in which lower-frequency components which are lower than a predetermined frequency are substantially fewer than higher-frequency components which are higher than the predetermined frequency, and the second case being that in which the lower-frequency components are substantially more than the higher-frequency components; and
a correction parameter output module configured to generate and output a correction parameter for the first and second parameters to enhance a sharpening process and a smoothing process more when the detected result indicates the second case than when the detected result indicates the first case, the sharpening process being performed by the sharpening module and the smoothing process being performed by the smoothing module.
